(19) United States
(12) Patent Application Publication
(10) Pub. No.: US 2025/0362507 A1
(43) Pub. Date: Nov. 27, 2025

(54) DISPLAY OPTICAL SYSTEM AND DISPLAY APPARATUS

(71) Applicant: CANON KABUSHIKI KAISHA, Tokyo (JP)

(72) Inventor: Yu MIYAJIMA, Tochigi (JP)

(21) Appl. No.: 19/204,814

(22) Filed: May 12, 2025

(30) Foreign Application Priority Data
May 24, 2024 (JP) 2024-084473

(51) Int. Cl. G02B 27/01; G02B 3/04

(52) U.S. Cl. CPC G02B 27/0172; G02B 3/04

(57) ABSTRACT

A display optical system is configured to guide light from a display surface of a display element to a pupil plane, and includes, in order from a pupil plane side to a display surface side, a first lens unit, a first transmissive reflective surface, a second lens unit, a second transmissive reflective surface, and a third lens unit. The second lens unit includes lenses having positive and negative on-axis refractive powers and different Abbe numbers based on d-line. At least one of the first lens unit and the third lens unit has a curved surface that serves as an interface with air. The Abbe number based on the d-line of the lens having the positive on-axis refractive power is larger than the Abbe number based on the d-line of the lens having the negative on-axis refractive power.

### BACKGROUND

### Technical Field

The present disclosure relates to a display optical system for a display apparatus such as a head mounted display (HMD).

### Description of Related Art

As an example of such a display optical system, Japanese Patent Application Laid-Open No. 07-261088 discloses a display optical system that has high optical performance and reduces chromatic aberration by using a cemented lens.

### SUMMARY

A display optical system according to one aspect of the disclosure is configured to guide light from a display surface of a display element to a pupil plane. The display optical system includes, in order from a pupil plane side to a display surface side, a first lens unit, a first transmissive reflective surface, a second lens unit, a second transmissive reflective surface, and a third lens unit. The second lens unit includes a lens having positive on-axis refractive power and a lens having negative on-axis refractive power and an Abbe number based on d-line different from that of the lens having the positive on-axis refractive power. At least one of the first lens unit and the third lens unit has a curved surface that serves as an interface with air in a range in which the light from the display surface passes. The Abbe number based on the d-line of the lens having the positive on-axis refractive power is larger than the Abbe number based on the d-line of the lens having the negative on-axis refractive power. An display apparatus having the above display optical system also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are a sectional view and an aberration diagram of a display optical system according to Example 1 without adjustment.

FIG. 2 illustrates an optical path of the display optical system according to Example 1.

FIGS. 3A and 3B are a sectional view and an aberration diagram of the display optical system according to Example 1 with −4D adjustment.

FIG. 4A and 4B explain a first transmissive reflective surface and a second transmissive reflective surface.

FIG. 5 illustrates an output angle β of a display element relative to an angle of view α according to Example 1.

FIGS. 6A and 6B illustrate sectional shapes of the optical element according to Example 1.

FIGS. 7A and 7B are a sectional view and an aberration diagram of an optical system according to Example 2.

FIG. 8 illustrates an output angle β of a display element relative to the angle of view α according to Example 2.

FIGS. 9A and 9B illustrate sectional shapes of the optical element according to Example 2.

FIG. 10 is a perspective view of an HMD having any one of the display optical systems according to Examples 1 and 2.

### DETAILED DESCRIPTION

Examples of the present disclosure will be described below with reference to the drawings. Prior to a detailed description of Examples 1 and 2, matters common to each example will be described.

An HMD, arranged as a display apparatus according to examples of the present disclosure includes a display element provided for each of the left and right eyes, and a display optical system configured to guide display light from a display surface of the display element to a pupil plane. Each display optical system guides a light beam from the display surface of the display element (panel) to the pupil plane (e.g., which may define an observation surface), and displays the display image by enlarging an original image displayed on the display surface.

The display optical system according to each example includes, in order from the pupil plane side to the display surface side, a pupil-plane-side optical system as a first optical system (first lens unit or first optical sub-system), a first transmissive reflective surface (first transmissive reflective member), a transmissive reflective optical system as a second optical system (second lens unit, or second optical sub-system), a second transmissive reflective surface (second transmissive reflective member), and a panel-side optical system as a third optical system (third lens unit, or third optical sub-system). Both the first transmissive reflective surface and the second transmissive reflective surface are curved surfaces.

The pupil-plane-side optical system is an optical system disposed between the pupil plane and the first transmissive reflective surface. The transmissive reflective optical system is an optical system disposed between the first and second transmissive reflective surfaces (sandwiched between the first and second transmissive reflective surfaces). The panel-side optical system is an optical system disposed between the second transmissive reflective surface and the display element.

The display optical systems (e.g., the first, second, and third lens units) of the display apparatuses according to Examples 1 and 2 will now be described in detail.

### Example 1

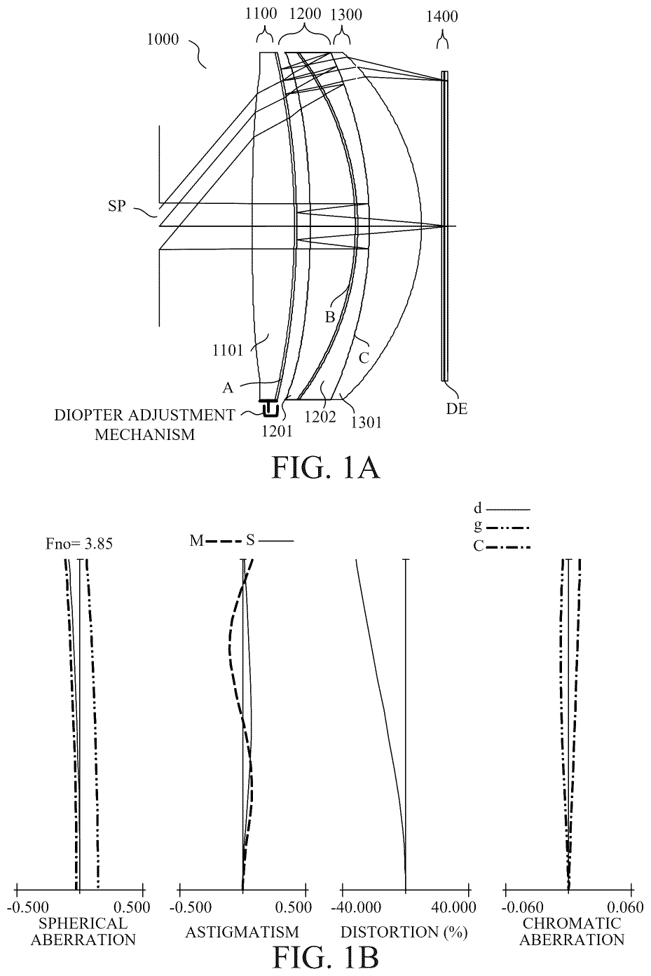

FIG. 1A illustrates the configuration of a display optical system 1000 for a single eye in an HMD according to Example 1. The display optical system 1000 includes, in order from the pupil plane side to the display surface side, a pupil-plane-side optical system (first optical system, first lens unit, or first optical sub-system) 1100, a first transmissive reflective member (A) having a first transmissive reflective surface, a transmissive reflective optical system (second optical system, second lens unit, or second optical sub-system) 1200, a second transmissive reflective member (C) having a second transmissive reflective surface, and a panel-side optical system (third optical system) 1300.

The pupil-plane-side optical system 1100 includes a first lens 1101 as a first optical element. The transmissive reflective optical system 1200 includes a second lens 1201 as a second optical element and a third lens 1202 as a third optical element. The panel-side optical system 1300 includes a fourth lens 1301 as a fourth optical element. Thus, in this example, the pupil-plane-side optical system 1100 includes one optical element (1101), the transmissive reflective optical system 1200 includes two optical elements (1201 and 1202), and the panel-side optical system 1300 includes one optical element (1301) that refracts, reflects, or diffracts a light ray. Each optical element has two optical surfaces, R1 and R2 surfaces, from the pupil plane side, and all of these optical surfaces are curved.

Display light from a panel unit 1400 including a display element passes through the panel-side optical system 1300, the second transmissive reflective surface (C), and a transmissive reflective optical system 2200. The display light is then reflected once each by the first transmissive reflective surface (A) and the second transmissive reflective surface (C), transmits through the transmissive reflective optical system 1200, and then passes through the pupil-plane-side optical system 1100 toward a pupil plane SP. Thereby, the observer can observe a virtual image (display image) of the original image displayed on the display element through his eye located at the pupil plane SP where the exit pupil of the display optical system 1000 is located. The light that follows the optical path to form the display image at this time is called display light, and the rest is called unnecessary light. In this example (and another example described later), the pupil plane SP is the position of the entrance pupil of the observer's eye, and is not the vertex of the cornea of the eye.

FIG. 1B illustrates the longitudinal aberration (spherical aberration, astigmatism, distortion, and chromatic aberration) of the display optical system 1000 according to this example in a case where the eye relief is set to 12 mm and a virtual image is displayed at a position 1600 mm from the pupil plane SP. The eye relief is a distance on the optical axis (also simply referred to as on the axis hereinafter) from the pupil plane SP to a lens surface closest to the pupil plane of the pupil-plane-side optical system 1100. The longitudinal aberration is illustrated in a case where the panel unit 1400 is the image plane in the reverse optical path (reverse tracing) from the pupil plane SP to the panel unit 1400, rather than the forward optical path (forward tracing) from the panel unit 1400 to the pupil plane SP. The longitudinal aberration in the reverse tracing corresponds to the longitudinal aberration in the forward tracing.

In the spherical aberration diagram, Fno represents an F-number. A solid line indicates a spherical aberration amount for the d-line (with a wavelength of 587.6 nm) which is the reference wavelength, an alternate long and two short dashes line indicates a spherical aberration amount for the g-line (with a wavelength of 435.8 nm), and an alternate long and short dash line indicates a spherical aberration amount for the C-line (with a wavelength of 656.3 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. The chromatic aberration diagram illustrates a lateral chromatic aberration amount for the g-line and C-line. From these aberration diagrams, it can be understood that the display optical system 1000 according to this example has excellent imaging performance.

The polarizing plate described below has the following specifications: a thickness of 0.1 mm, a refractive index at the d-line of 1.52, and an Abbe number based on the d-line of 50. The quarter waveplate and the laminated element between the quarter waveplate and the polarization selective transmissive reflective element have the following specifications: a thickness of 0.3 mm, a refractive index at the d-line of 1.52, and an Abbe number based on the d-line of 50. However, the actual specifications may differ from these values.

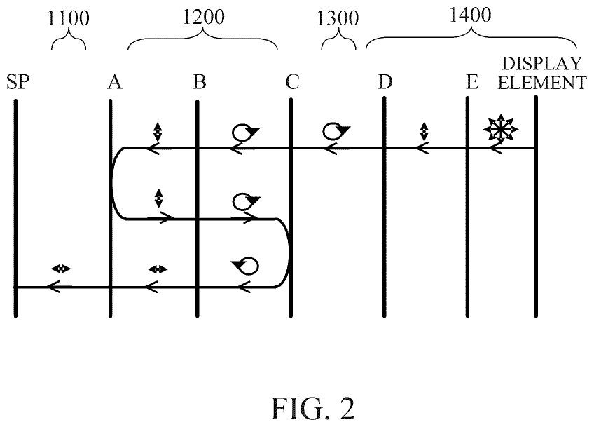

FIG. 2 illustrates the direction and polarization state of the display light passing through each surface in the display optical system 1000. The panel unit 1400 has a display element (light modulation element) such as a liquid crystal display element or an organic EL element, a polarizing plate E, and a second quarter waveplate D. The display element has a square shape with a diagonal length of 2.1 inches (one side is 37.7 mm). A display element, a polarizing plate E, and a second quarter waveplate D are arranged in close proximity to each other in this order toward the pupil plane.

The display light emitted from the display element as unpolarized light is converted into linearly polarized light by the polarizing plate E. This linearly polarized light is converted into circularly polarized light by the second quarter waveplate D, and the circularly polarized light transmits through the panel-side optical system 1300 and then transmits through the transmissive reflective film (half-mirror) C as the second transmissive reflective member having the second transmissive reflective surface, and enters the transmissive reflective optical system 1200.

The transmissive reflective film C is formed of a dielectric multilayer film or a metal film, and deposited on the R1 surface of the fourth lens 1301 of the panel-side optical system 1300, and bonded to the R2 surface of the third lens 1202. The thickness of the transmissive reflective film C is usually 1000 nm or less or 5000 nm or less, and is not illustrated in the figures or in the numerical examples described below.

The polarizing plate E may be integrated with the display element. For example, many liquid crystal display elements include a polarizing plate in their configuration, and polarizing plates are sometimes used in organic EL elements for antireflection, in which case the light emitted from the display element becomes linearly polarized. In this case, there is no need to provide a separate polarizing plate E.

The transmissive reflective optical system 1200 includes a third lens 1202, a

first quarter waveplate B, and a second lens 1201. The first quarter waveplate B is disposed so that its slow axis is tilted by 90° relative to the slow axis of the second quarter waveplate D, and is tilted by 45° relative to the polarized transmission axis of the polarizing plate E. The first quarter waveplate B is adhered to the R1 surface of the second lens 1201.

The circularly polarized light incident on the transmissive reflective optical system 1200 is converted by the first quarter waveplate B into linearly polarized light in the same polarization direction as that when it passed through the polarizing plate E, and then enters the polarization-selective transmissive reflective element A. This linearly polarized light is reflected by the polarization selectivity of the polarization-selective transmissive reflective element A.

The polarization-selective transmissive reflective element A is an element configured to reflect linearly polarized light in the same polarization direction as that when it passed through the polarizing plate E and transmits linearly polarized light in a polarization direction orthogonal to it, and includes, for example, a wire grid polarizer or a laminated birefringent film polarizer. An example of a wire grid polarizer is “WGF” manufactured by Asahi Kasei Corporation, and the wire grid forming surface functions as a transmissive reflective surface. In this example, the thickness of the polarization-selective transmissive reflective element A is usually 0.5 mm or less or 1 mm or less, and is adhered to the R2 surface of the first lens 1101 of the pupil-plane-side optical system 1100.

Each transmissive reflective member includes a transmissive reflective surface, is a member that is integrated with the transmissive reflective surface, has almost no refractive power, and is a member that mainly performs an optical function other than refraction (such as absorption according to the polarization state, change of the polarization state, and antireflection) and mechanical functions (such as adhesion and protection). In this example, the polarization-selective transmissive reflective element A corresponds to the first transmissive reflective member having the first transmissive reflective surface, and the transmissive reflective film C corresponds to the second transmissive reflective member having the second transmissive reflective surface. Each transmissive reflective member may include a series of members having a plurality of functions.

The display light reflected by the polarization-selective transmissive reflective element A is converted by the first quarter waveplate B into circularly polarized light of the same rotation as that when it was first converted into circularly polarized light by the second quarter waveplate D, and enters the transmissive reflective film C, where it is reflected.

The display light reflected by the transmissive reflective film C becomes circularly polarized light in the opposite rotating direction to that of the pre-reflection light, enters the first quarter waveplate B again, and is converted into linearly polarized light with a polarization direction orthogonal to the polarization direction in a case where it first passed through the polarizing plate E, and enters the polarization-selective transmissive reflective element A. This linearly polarized light transmits the polarization selectivity of the polarization-selective transmissive reflective element A and is guided to the pupil plane SP. Thus, the display optical system 1000 employs a triple path that folds the optical path twice, and is thus able to display a sufficiently enlarged display image with a reduced size.

### Weight of Display Optical System

The transmissive reflective optical system 1200, in which a light ray passes three times, is more effective in reducing chromatic aberration than the pupil-plane-side optical system 1100 or the panel-side optical system 1300, in which a light ray passes only once. In this case, the shape of the optical surface to reduce chromatic aberration may have a moderate curvature and a sag amount from the plane, which is for weight reduction.

The display optical system disclosed in Japanese Patent Application Laid-Open No. 07-261088 uses a cemented lens in the transmissive reflective optical system to reduce chromatic aberration. Selecting a combination of glass materials with proper refractive index and Abbe number can reduce the field curvature and astigmatic difference without providing a curved surface that serves as an interface with air in the pupil-plane-side optical system and the panel-side optical system. However, the combination of glass materials that can achieve this is quite limited, and it is difficult to select a glass material suitable for weight reduction.

In order to reduce the weight of the display optical system, it is particularly effective to use a resin material with a low specific gravity instead of a glass material. However, resin materials have fewer variations in refractive index and Abbe number compared to the glass materials. In particular, for lenses in the transmissive reflective optical systems, only resin materials with a fairly small birefringence amount that changes a polarization state can be used to avoid the generation of unnecessary light.

It is therefore important to satisfactorily reduce chromatic aberration, field curvature, and astigmatic difference while a certain degree of freedom in the selection of lens materials is secured. One approach is to select a resin material that reduces chromatic aberration in a situation where there is little freedom in the selection of resin materials with proper refractive index and Abbe number, and to correct the increased field curvature and astigmatic difference.

To reduce chromatic aberration, it is effective to reduce chromatic aberration in the transmissive reflective optical system 1200 as described above. More specifically, a lens with positive on-axis power (power is a reciprocal of a focal length, also called refractive power) and a lens with negative on-axis power are provided to the transmissive reflective optical system 1200. The following inequality (1) may be satisfied:

$$20 \leq v 1 - v 2 \qquad ( 1 )$$

where v1 is an Abbe number based on the d-line of a lens having positive on-axis power, and v2 is an Abbe number based on the d-line of a lens having negative on-axis power.

Inequality (1) may be replaced with inequality (1a) below:

$$25 \leq v 1 - v 2 \qquad ( 1 a )$$

Inequality (1) may be replaced with inequality (1b) below:

$$30 \leq v 1 - v 2 \qquad ( 1 b )$$

These inequalities with Abbe number differences impose some constraints on the selection of resin materials, but since there are no constraints on the refractive index, ample freedom is secured in the selection of resin materials.

In order to correct increases in field curvature and astigmatic difference, it is effective to provide a curved surface that serves as an interface with air in at least one of the pupil-plane-side optical system 1100 and the panel-side optical system 1300. Since the light rays that pass through the transmissive reflective optical system 1200 three times pass through different positions on the optical surface, it is difficult to optimize the field curvature and astigmatic difference of the light beam for each angle of view using the optical surface in the transmissive reflective optical system 1200. In order to reduce both the field curvature and astigmatic difference, the pupil-plane-side optical system 1100 and the panel-side optical system 1300 may be spaced apart from each other, and a curved surface that serves as an interface with air may be provided to at least one of these optical systems, so as to properly set the field curvature and astigmatic difference of the light beam for each angle of view. This allows for sufficient freedom in the selection of resin materials while favorably reducing chromatic aberration, field curvature, and astigmatic difference.

Even if a curved surface is provided on the cemented surface rather than on the interface with air, it is difficult to sufficiently correct the field curvature and astigmatic difference because the refraction effect is small.

In this example, the transmissive reflective optical system 1200 is provided with the second lens 1201 having positive on-axis power and a third lens 1202 having negative on-axis power. v1 is an Abbe number of the second lens 1201 based on the d-line, and v2 is an Abbe number of the third lens 1202 based on the d-line, which is cemented to the second lens 1201 via the first quarter waveplate B (while the first quarter waveplate B is sandwiched between the second lens 1201 and third lens 1202). In this case, v1=56.0, v2=22.38, and 30≤v1−v2=34.62, which satisfies inequality (1).

Both the second lens 1201 and the third lens 1202 are resin lenses, and using them can reduce the weight compared to using glass lenses. As mentioned above, the birefringence of these resin materials is quite small, so unnecessary light can be reduced.

This example thus provides the transmissive reflective optical system 1200 with lenses having positive and negative on-axis powers, and sets a difference between their Abbe numbers to a predetermined value or more, thereby reducing the weight and chromatic aberration of the display optical system 1000. Cementing in this example is not limited to adhesion using an adhesive agent, but includes vapor deposition and pressure bonding. The cementing only needs to be performed in at least the effective ray area through which light passes.

In this example, the R1 surface of the first lens 1101 in the pupil-plane-side optical system 1100 and the R2 surface of the fourth lens 1301 in the panel-side optical system 1300 are curved surfaces that form an interface with air. Thus, providing a curved surface that forms an interface with air in at least one of the panel-side optical system 1300 and the pupil-plane-side optical system 1100 can correct the field curvature and the astigmatic difference.

In a display optical system with a wide viewing angle such as this example, the field curvature and the astigmatic difference tend to increase. Thus, the configuration may use an aspheric surface to correct them. In that case, surfaces with particularly strong curvature are likely to have a shape with a small sag amount from a flat surface, which is convenient for weight reduction of the lens.

In this example, both the panel-side optical system 1300 and the pupil-plane-side optical system 1100, which are spaced apart from each other, have aspheric surfaces that form interfaces with the air. Thereby, the field curvature and astigmatic difference can be reduced with higher accuracy than that in providing an aspheric surface only on one of the panel-side optical system 1300 and the pupil-plane-side optical system 1100. This configuration also contributes to reducing the exit angle, which will be described later.

This example can effectively reduce chromatic aberration, field curvature, and astigmatism (astigmatic difference) as illustrated in FIG. 1B, while ensuring sufficient freedom in the selection of resin materials.

In this example, the cemented surface between the second lens 1201 and the third lens 1202 via the first quarter waveplate B in the transmissive reflective optical system 1200 contributes to the reduction of chromatic aberration. The shapes of the first and second transmissive reflective surfaces affect the overall imaging performance, so there is no design freedom with the primary objective of reducing chromatic aberration. In a case where the cemented surface is provided in the transmissive reflective optical system 1200, as in this example, the shape does not significantly affect imaging performance other than chromatic aberration, and increases the design freedom with the primary objective of reducing chromatic aberration, so a high chromatic aberration reduction effect can be obtained. Moreover, compared to the case where the second lens 1201 and the third lens 1202 are not cemented, an increase in chromatic aberration caused by assembly errors during manufacturing can be suppressed and manufacturing can become easier.

In order to reduce the sensitivity to imaging performance due to manufacturing errors and positioning errors other than chromatic aberration, the power difference between a lens having positive on-axis power and a lens having negative on-axis power may not be large. More specifically, the following inequality (2):

$$0.25 \leq \vert f 2 / f 1 \vert \leq 4. \qquad ( 2 )$$

where f1 is a focal length of the second lens 1201 having positive on-axis power, and f2 is a focal length of the third lens 1202 having negative on-axis power. The focal lengths referred to here are paraxial focal lengths.

In this example, f1=100.9 mm, f2=−215.1 mm, 0.25≤|f2/f1|=2.13≤4.00, and inequality (2) is satisfied.

In this example, as described above, the second lens 1201 and the third lens 1202 are cemented together via the first quarter waveplate B. Thereby, the refractive power at the surface of the first quarter waveplate B can be reduced, and this configuration can advantageously tolerate the surface roughness standard of the first quarter waveplate B, which is made of a material softer than the lens. An antireflection coating may not be provided to the first quarter waveplate B, and the first quarter waveplate B can be manufactured separately from the transmissive reflective member.

In this example, the cemented surface is spherical. Thereby, the second lens 1201 and the third lens 1202 can be more easily manufactured than the case where they are made complex aspheric.

In terms of weight reduction, the display optical system 1000 for the HMD may have an overall thickness on the optical axis of optical elements having refractive or diffractive power of 20 mm or less. In this example, the thicknesses d111, d121, d122, and d131 of the first lens 1101, second lens 1201, third lens 1202, and fourth lens 1301, and their sum d1sum, are as follows: d111=5.4 mm, d121=5.8 mm, d122=1.5 mm, d131=6.7 mm, and d1sum=19.4 mm

d1sum is 20 mm or less. The polarizing plate, quarter waveplate, and polarization-selective transmissive reflective element have little influence on the weight of the display optical system 1000, so their thicknesses do not need to be taken into consideration.

In this example, there is an air gap between the polarization-selective transmissive reflective element A and the optical element (second lens 1201). That is, the transmissive reflective optical system 1200 sandwiched between the first transmissive reflective surface and the second transmissive reflective surface has an air gap. Thereby, the weight of the display optical system 1000 can be lighter than the case in which the transmissive reflective optical system 1200 is occupied by optical elements without an air gap.

This example provides a diopter adjustment mechanism that performs diopter adjustment using the air gap to drive the first lens 1101 having the polarization-selective transmissive reflective element A as illustrated in FIG. 1A. Thereby, focusing (diopter adjustment) can be performed to suit the visual acuity (viewing angle) of various observers.

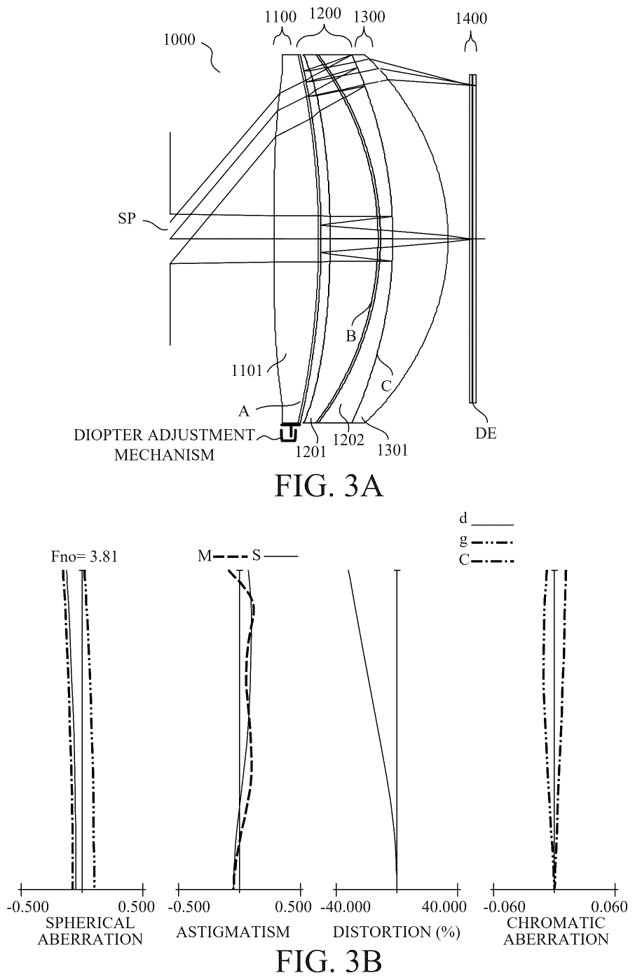

FIG. 3A illustrates an optical path in a case where the diopter is adjusted for a person with a viewing angle of −4D (myopia), and FIG. 3B illustrates the longitudinal aberration at that time. It can be understood from FIG. 3B that even with diopter adjustment, sufficiently good imaging performance is obtained.

In this example, a distance between the polarization-selective transmissive reflective element A and the transmissive reflective film C is highly sensitive to the focus position, so a drive amount of the first lens 1101 in adjusting the diopter is reduced. As a result, the size (thickness) and weight of the HMD can be reduced even with a diopter adjustment mechanism.

Reducing the size (thickness) of the display optical system 1000 can reduce

the members that hold the display optical system 1000, and further reduce the weight of the HMD. In order to reduce the size of the display optical system 1000, the focal length of the display optical system 1000 may be reduced. If the focal length is reduced at a wide viewing angle, the field curvature and astigmatic difference are likely to increase. This disadvantage may be solved by providing a curved surface that serves as an interface with the air. In other words, this configuration may be combined with the above configuration. For this reason, it is effective to make the on-axis powers of the pupil-plane-side optical system 1100 and the panel-side optical system 1300 both positive. In terms of imaging performance, the on-axis power of the transmissive reflective optical system 1200 is positive. As a result, the on-axis powers of all three optical systems 1100, 1200, and 1300 are positive. In this case, the focal length of the display optical system 1000 is more likely to be reduced than the case where the on-axis power of at least one of the pupil-plane-side optical system 1100 and the panel-side optical system 1300 is negative.

In this example, the focal length of the pupil-plane-side optical system 1100 is 176.5 mm, and the focal length of the panel-side optical system 1300 is 109.9 mm, both of which are positive.

In this example, the R1 surface of the first lens 1101, which serves as a pupil opposing surface that is opposite to the pupil plane SP, has a convex shape toward the pupil plane. In reversely tracing the optical path from the pupil plane SP, the refraction of the light beam on the pupil opposing surface is greater in a case where the pupil opposing surface has a planar or convex shape than in a case where the pupil opposing surface has a concave shape toward the pupil plane. Therefore, the size of the display optical system 1000 can be reduced in a radial direction, and the weight of the display optical system 1000 to be reduced.

In a case where the pupil opposing surface has a concave shape toward the pupil plane, the optical surface may protrude toward the pupil plane beyond the eye relief, and may interfere with the observing eye. In particular, the holding member that holds the first lens 1101 having the pupil opposing surface is more likely to protrude toward the pupil plane. Therefore, the pupil opposing surface may have at least a planar shape, or may have a convex shape toward the pupil plane.

As described above, the display optical system 1000 according to this example has one lens in the pupil-plane-side optical system 1100, two lenses in the transmissive reflective optical system 1200, and one lens in the panel-side optical system 1300, i.e., a total of four optical elements. This is the minimum number of optical elements to obtain the effects described above, and is suitable for the size (thinness) and weight reduction and improved manufacturing of the display optical system 1000.

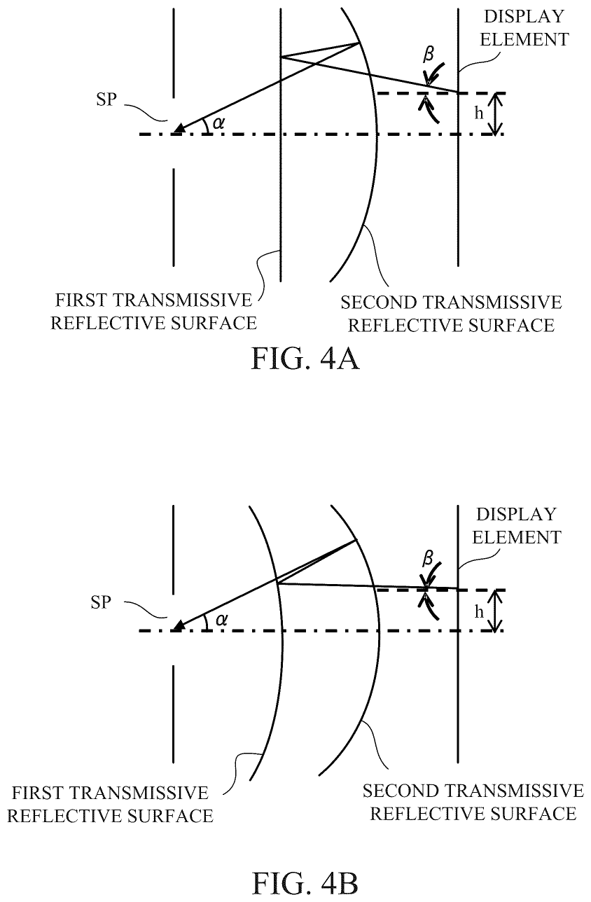

A description will now be given of the exit angle of the display light from the display element, which is related to the field curvature, astigmatism, and size reduction. FIGS. 4A and 4B illustrate optical paths of a light ray emitted from the image height h on the display element, an exit angle β of a light ray from the display element, and an angle of view α on the pupil plane SP in a case where the first transmissive reflective surface (polarization-selective transmissive reflective element A) has a planar shape and a concave shape toward the pupil plane side, respectively. Here, refraction is not illustrated in order to explain the reflection of the light ray. The curved surface will be described as a spherical surface.

The display element normally provides Lambertian light emission. As the exit angle β decreases, the display optical system takes in a larger light amount, and as the exit angle β increases, the display optical system takes in a smaller light amount. Thus, if the maximum value of the exit angle β is large within a range of a designed viewing angle, light amount unevenness occurs in the field of view of the observation projection. As described above, as the angle of view α (i.e., viewing angle) increases, the observer can easily feel immersed, but the maximum value of the exit angle β tends to be large.

FIG. 4A illustrates the first transmissive reflective surface having a flat shape and the second transmissive reflective surface (transmissive reflective film C) having a concave shape toward the pupil plane side. This configuration is suitable to increase the angle of view α, but is not suitable to decrease the exit angle β. FIG. 4B illustrates the first and second transmissive reflective surfaces both having a concave shape toward the pupil plane side. This configuration is suitable to decrease the exit angle β and increase the angle of view α.

In other words, when only reflection is considered, a configuration in which both the first and second transmissive reflective surfaces have a concave shape toward the pupil plane, as illustrated in FIG. 4B, is suitable for the exit angle β and the angle of view α.

The first and second transmissive reflective surfaces both having a concave shape toward the pupil plane may be aspherical, in order to effectively reduce field curvature and astigmatic difference, particularly in a display optical system with a wide viewing angle. In this example, the R2 surface of the first lens 1101 following the first transmissive reflective surface (polarization-selective transmissive reflective element A) is aspheric rather than spheric.

In this example, the third lens 1202 and fourth lens 1301, which are refractive elements, are cemented together via the second transmissive reflective member (transmissive reflective film C) including the second transmissive reflective surface (while the second transmissive reflective member is sandwiched between the third lens 1202 and fourth lens 1301). The refractive power on the second transmissive reflective surface in this configuration is smaller than that of the second transmissive reflective surface that contacts air. As a result, in determining the shape of the second transmissive reflective surface, it is sufficient to mainly consider the influence of the reflective power, and the degree of freedom of optical design is improved. Thereby, the imaging performance can be improved and the exit angle β can be reduced. This is particularly effective in the display optical system 1000 with a wide viewing angle in order to reduce the field curvature and astigmatic difference. Cementing the third lens 1202 and the fourth lens 1301 can improve the relative positional accuracy of these lenses, and manufacturing can be easier.

Although it depends on the characteristic of the display element, generally, if the maximum absolute value of the exit angle β is greater than 35°, light amount unevenness is likely to occur. Therefore, the maximum absolute value of the exit angle β may be 35° or less, or 30° or less.

In order to reduce the maximum absolute value of the exit angle β, it is effective to provide an aspheric surface to the optical surface that interfaces with the air of the panel-side optical system 1300. This is because a light beam for each angle of view is separated in the panel-side optical system 1300 compared to the pupil-plane-side optical system 1100 and the transmissive reflective optical system 1200.

This example assumes a maximum half angle of 50° as a design viewing angle in the design appellation. More specifically, a maximum angle of a principal ray of the display light (a light ray passing through the center of the pupil plane SP) that passes through the pupil plane SP is set to 50°. Generally, a maximum half angle of 30° or more or 40° or more can be a wide viewing angle, because as a viewing angle (the exit angle β) increases, the light amount unevenness increases.

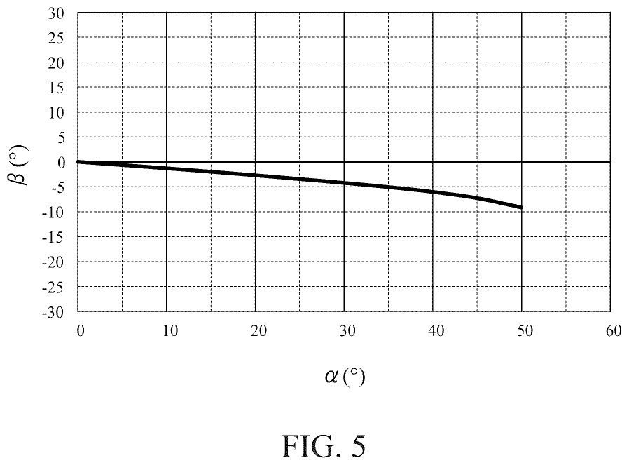

FIG. 5 illustrates the exit angle β (angle relative to the normal to the display element) of the principal ray from the display element relative to the angle of view α of the display optical system 1000. The exit angle β is negative (−) in a case where it is emitted in a direction away from the optical axis, and positive (+) in a case where it is emitted in a direction approaching the optical axis.

It may be understood from FIG. 5 that the exit angle β=−9.1° at the maximum half angle of view, and the maximum absolute value of the exit angle β is smaller than 30°. In evaluating the light amount unevenness, the exit angle β is evaluated in terms of absolute value, rather than in terms of positive or negative signs.

In a case where the exit angle β at the maximum half angle of view is negative as in this example, the size of the display element for the viewing angle and eye relief specifications can be reduced, which is convenient for weight reduction.

A description will now be given of the aspheric shapes of the optical surfaces that form the interfaces with air of the pupil-plane-side optical system 1100 and the panel-side optical system 1300.

In order to reduce the field curvature and astigmatic difference for each angle of view with high accuracy in the display optical system 1000 with a wide viewing angle, an effective ray area (a range through which the display light from the display element can pass) of at least one optical surface may have a high-order aspheric shape. More specifically, the sectional shape including the optical axis may have a shape that cannot be expressed by a conic section (i.e., an ellipse, a parabola, or a hyperbola). This is suitable to reduce the emission angle β.

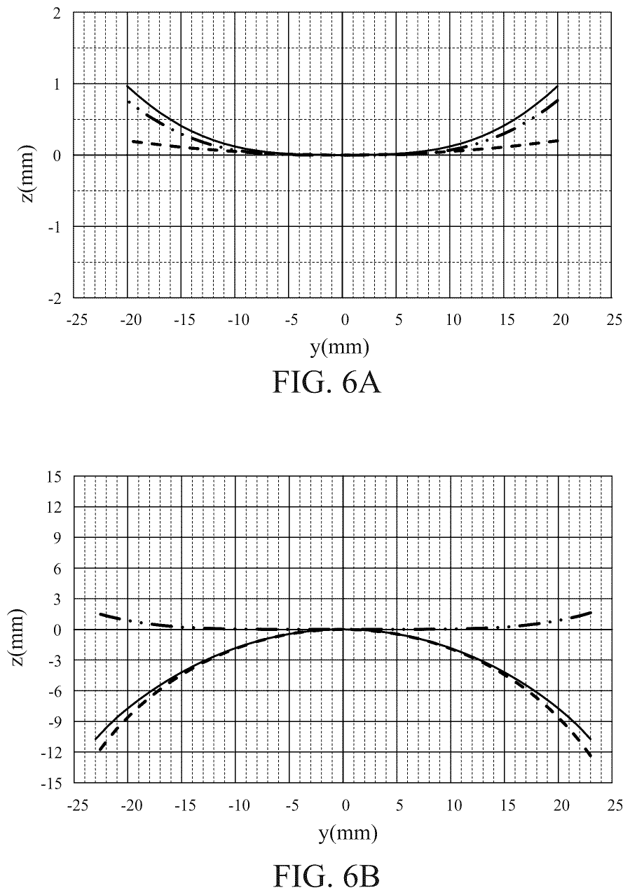

FIGS. 6A and 6B illustrate, by solid lines, a sectional shape including the optical axis of the R1 surface of the first lens 1101 and a sectional shape including the optical axis of the R2 surface of the fourth lens 1301, respectively. A position of each surface in the optical axis direction is z (mm), a surface vertex is z=0, and it is positive from the pupil plane side to the display surface side. A radial distance from the optical axis is y (mm). A scale of the graph differs for each surface. The R1 surface of the first lens 1101 and the R2 surface of the fourth lens 1301 have sectional shapes that cannot be expressed by a conic section.

FIG. 6A further illustrates a paraxial curvature surface shape of a section including the optical axis of the R1 surface of first lens 1101 by a broken line, and a difference from the sectional shape illustrated by a solid line by an alternate long and two short dashes line. FIG. 6B further illustrates the paraxial curvature surface shape of a section including the optical axis of the R2 surface of the fourth lens 1301 by a dashed line, and a difference from the sectional shape illustrated by a solid line by an alternate long and two short dashes line.

The absolute value of the ratio of the above difference relative to the paraxial curvature surface shape indicates the degree of aspherization (hereinafter referred to as asphericity). Although it is not proportional to the asphericity, a relatively large asphericity is more effective in reducing the exit angle β and reducing the field curvature and astigmatic difference with high accuracy for each angle of view. In general, the asphericity increases toward the end of the effective ray area, and the above effect is easily achieved if the asphericity at the end of the effective ray area is 30% or more. In other words, the following inequality may be satisfied:

$$0.3 \leq \vert ( SagA - SagR ) / SagR \vert$$

where SagR is a sag amount of the paraxial curvature surface shape at the end of the effective ray area of the aspheric surface, and SagA is a sag amount of the sectional shape of the aspheric surface.

In a case where the asphericity at the end of the effective ray area is 50% or more, the above effect can be sufficiently achieved. However, even if the asphericity at the end of the effective ray area is less than 30%, the above effect can be achieved to some extent.

In this example, the sag amount SagA of the sectional shape including the optical axis at the end of the effective ray area of the R1 surface of the first lens 1101 (maximum effective diameter Φ40 mm) is 0.96 mm, and the sag amount SagR of the paraxial curvature surface shape is 0.20 mm. The asphericity at the end of the effective ray area is |(SagA−SagR)/SagR|=380%.

The sag amount SagA of the sectional shape including the optical axis at the end of the effective ray area of the R2 surface of the fourth lens 1301 (maximum effective diameter Φ46 mm) is −10.73 mm, and the sag amount SagR of the paraxial curvature surface shape is −12.34 mm. The asphericity at the end of the effective ray area is |(SagA−SagR)/SagR|=13.0%.

Thus, setting the asphericity at the end of the effective ray area to 50% or more, particularly on the R1 surface of the first lens 1101 can provide sufficient effects such as reducing the exit angle β and reducing the field curvature and astigmatic difference with high accuracy for each angle of view.

This example can secure high optical performance and reduce chromatic aberration and weight for the display optical system 1000.

### Example 2

A description will now be given of a display optical system 2000 according to Example 2. This example will omit a description of any features which are common with Example 1.

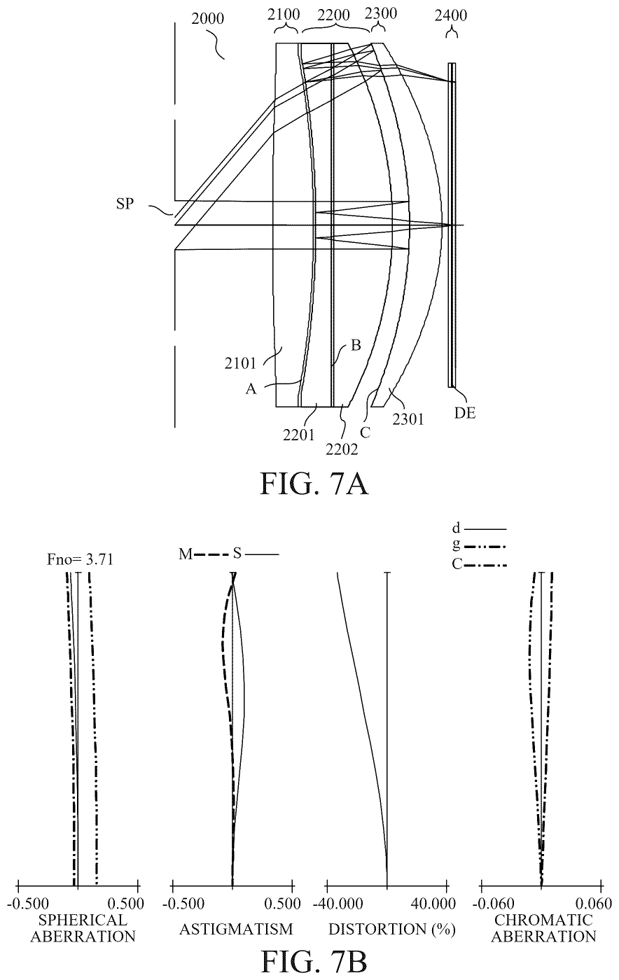

FIG. 7A illustrates the configuration of the display optical system 2000. The display optical system 2000 includes, in order from the pupil plane side to the display surface side, a pupil-plane-side optical system (first optical system, first lens unit, or first optical sub-system) 2100, a first transmissive reflective member (A) having a first transmissive reflective surface, a transmissive reflective optical system (second optical system, second lens unit, or second optical sub-system) 2200, a second transmissive reflective member (C) having a second transmissive reflective surface, and a panel-side optical system (third optical system, third lens unit, or third optical sub-system) 2300.

The pupil-plane-side optical system 2100 includes a first lens 2101 as a first optical element. The transmissive reflective optical system 2200 includes a second lens 2201 as a second optical element and a third lens 2202 as a third optical element. The panel-side optical system 2300 includes a fourth lens 2301 as a fourth optical element. Thus, the pupil-plane-side optical system 2100 includes one optical element 2101, the transmissive reflective optical system 2200 includes two optical elements 2201 and 2202, and the panel-side optical system 2300 includes one optical element 2301 that refracts, reflects or diffracts light rays. Both the R1 and R2 surfaces of first lens 2101 are curved surfaces. The R1 surface of the second lens 2201 is curved and the R2 surface of the second lens 2201 is flat. The R1 surface of the third lens 2202 is flat and the R2 surface of the third lens 2202 is curved. Both the R1 and R2 surfaces of the fourth lens 2301 are curved.

Display light from a panel unit 2400 including a display element transmits through the panel-side optical system 2300, the second transmissive reflective surface (C), and the transmissive reflective optical system 2200. The display light is reflected once each by the first transmissive reflective surface (A) and the second transmissive reflective surface (C), transmits through the transmissive reflective optical system 2200, and then transmits through the pupil-plane-side optical system 2100 toward the pupil plane SP. Thereby, the observer can view a virtual image (display image) of the original image displayed on the display element through his eye located at the pupil plane SP where the exit pupil of the display optical system 2000 is located.

FIG. 7B illustrates the longitudinal aberration of the display optical system 2000 in a case where the eye relief (a distance from the pupil plane SP to a lens surface closest to the pupil plane of the pupil-plane-side optical system 2100) is set to 12 mm and a virtual image is displayed at a position 1600 mm from the pupil plane SP. The description of each aberration diagram is the same as according to Example 1 (FIG. 1B, etc.). It is understood from FIG. 7B that the display optical system 2000 according to this example has good imaging performance.

The configuration of the panel unit 2400 is similar to that of the panel unit 1400 in Example 1. The transmissive reflective film (half-mirror) C is deposited on the R1 surface of the fourth lens 2301. The first quarter waveplate B is adhered to the R2 surface of the second lens 2201 and the R1 surface of the third lens 2202. The polarization-selective transmissive reflective element A is adhered to the R2 surface of the first lens 2101 of the pupil-plane-side optical system 2100 and the R1 surface of the second lens 2201 of the transmissive reflective optical system 2200. In this example, the polarization-selective transmissive reflective element A corresponds to the first transmissive reflective member having a first transmissive reflective surface, and the transmissive reflective film C corresponds to the second transmissive reflective member having a second transmissive reflective surface.

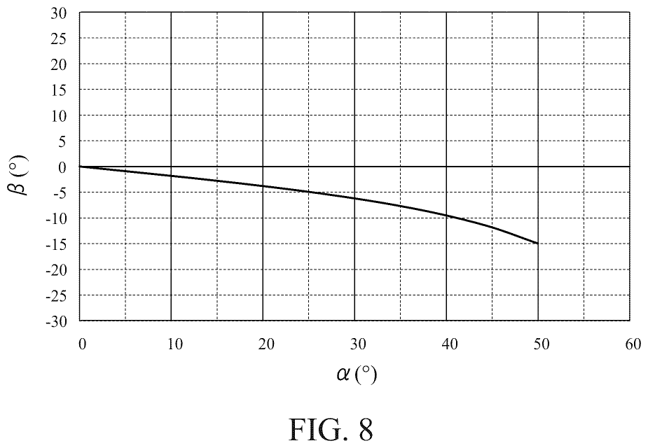

FIG. 8 illustrates a direction and polarization state of the display light passing through each surface in the display optical system 2000. The direction and polarization state of the display light are the same as according to Example 1 (FIG. 2).

In this example, the transmissive reflective optical system 2200 includes a third lens 2202 with positive on-axis power and a second lens 2201 with negative on-axis power. The third lens 2202 and the second lens 2201 are cemented together via a first quarter waveplate B (while the first quarter waveplate B is sandwiched between the third lens 2202 and the second lens 2201). Where v1 is an Abbe number of the third lens 2202 based on the d-line, and v2 is an Abbe number of the second lens 2201 based on the d-line, v1=56.0, v2=22.38, and 30≤v1−v2=34.62, which satisfies inequality (1).

As in Example 1, the second lens 2201 and the third lens 2202 are both resin lenses, and the weight can be lighter than that in a case where glass lenses are used. These resin materials have a very small birefringence, and unnecessary light can be reduced.

Thus, providing two lenses having positive and negative on-axis powers to the transmissive reflective optical system 2200 and setting a difference in the Abbe numbers of the respective resin materials to a predetermined value or more can reduce the weight and chromatic aberration of the display optical system 2000.

In this example, the R1 surface of the first lens 2101 of the pupil-plane-side optical system 2100 and the R2 surface of the fourth lens 2301 of the panel-side optical system 2300 are curved surfaces that interface with the air. Thus, providing a curved surface that interfaces with the air in at least one of the panel-side optical system 2300 and the pupil-plane-side optical system 2100 can correct the field curvature and astigmatic difference.

Even in this example, as in Example 1, the R1 surface of the first lens 2101, which is an interface with air, and the R2 surface of the fourth lens 2301 of the panel-side optical system 2300 are aspheric surfaces in both the panel-side optical system 2300 and the pupil-plane-side optical system 2100. This configuration has the effect of reducing the exit angle β and the field curvature and astigmatism with high accuracy. This configuration also contributes to reducing the exit angle from the display element.

Thus, this example can satisfactorily reduce chromatic aberration, field curvature, and astigmatism (astigmatic difference) as illustrated in FIG. 7B while ensuring sufficient freedom in selecting the resin material.

In this example, as according to Example 1, the transmissive reflective optical system 2200 has a cemented surface where the second lens 2201 and the third lens 2202 are cemented via the first quarter waveplate B, so that chromatic aberration can be reduced.

In this example, the focal length f1 of the third lens 2202 with positive on-axis power and the focal length f2 of the lens with negative on-axis power are: f1=90.1 mm, f2=−186.9 mm, 0.25≤|f2/f1|=2.07≤4.00, and inequality (2) is satisfied. Thereby, the sensitivity to imaging performance due to manufacturing errors and positioning errors other than chromatic aberration can be reduced.

In this example, as in Example 1, the second lens 2201 and the third lens 2202 are cemented via the first quarter waveplate B, so that the surface roughness standard of the first quarter waveplate B can be tolerated. An antireflection film may not be formed on the first quarter waveplate B, and the first quarter waveplate B can be manufactured separately from the transmissive reflective member.

In this example, the cemented surface is flat. Thereby, the second lens 2201 and the third lens 2202 can be more easily manufactured than the case where they are spherical as in Example 1. Since there is no need to bend the first quarter waveplate B disposed between the second lens 2201 and the third lens 2202, it is easier to cement the second lens 2201 and the third lens 2202 together via the first quarter waveplate B.

The thicknesses d211, d221, d222, and d231 on the optical axis of each of

the first lens 2101, the second lens 2201, the third lens 2202, and the fourth lens 2301 of the display optical system 2000 according to this example and their sum d2sum are as follows: d211=5.0 mm, d221=1.9 mm, d222=7.2 mm, d231=4 mm, and d2sum=18.1 mm.

d2sum is 20 mm or less, reducing the weight of the display optical system 200.

In this example, there is an air gap between the third lens 2202 and the transmissive reflective film C. That is, the transmissive reflective optical system 2200 sandwiched between the first transmissive reflective surface and the second transmissive reflective surface has an air gap. Thereby, the weight of the display optical system 2000 can be reduced.

Reducing the size (thickness) of the display optical system 2000 can reduce the sizes of the members that hold the display optical system 2000, and further reduce the weight of the HMD. This example is effective to make the on-axis powers of both the pupil-plane-side optical system 2100 and the panel-side optical system 2300 positive. In terms of imaging performance, the on-axis power of the transmissive reflective optical system 2200 is positive. As a result, the on-axis powers of all three optical systems 2100, 2200, and 2300 are positive, and it is easier to reduce the focal length of the display optical system 2000 compared to the case where the on-axis power of at least one of the pupil-plane-side optical system 2100 and the panel-side optical system 2300 is negative.

In this example, the focal length of the pupil-plane-side optical system 2100 is 218.2 mm, and the focal length of the panel-side optical system 2300 is 150.2 mm, both of which are positive. Therefore, as in Example 1, the thickness of the display optical system 2000 can be reduced.

In this example, the R1 surface of the first lens 2101, which serves as the pupil opposing surface, has a convex shape toward the pupil-side surface. Thereby, the size of the display optical system 200 can be reduced in the radial direction, as in Example 1.

In this example, as in Example 1, the pupil-plane-side optical system 2100 includes one lens, the transmissive reflective optical system 2200 includes two lenses, and the panel-side optical system 2300 includes one lens, i.e., a total of four optical elements. This is suitable for the size and weigh reduction of the display optical system 2000 and easy manufacturing.

Even in this example, as in Example 1, the shape of the R2 surface of the second lens 2201 following the first transmissive reflective surface (polarization-selective transmissive reflection element A) is aspheric, and the field curvature and astigmatic difference are effectively reduced.

In this example, the first lens 2101, which is a refractive element, and the second lens 2201 are cemented together via the first transmissive reflective member (polarization-selective transmissive reflection element A) including the first transmissive reflective surface (while the first transmissive reflective member is sandwiched between the first lens 2101 and the second lens 2201). Due to this configuration, the refractive power of the first transmissive reflective surface can be reduced compared to the case where the first transmissive reflective surface contacts air. As a result, in determining the shape of the first transmissive reflective surface, it is sufficient to mainly consider the influence of the reflective power, and the degree of freedom in optical design is improved. Thereby, the imaging performance can be improved while the exit angle β is reduced. This is particularly effective in reducing the field curvature and astigmatic difference in the display optical system 2000 with a wide viewing angle. Cementing the first lens 2101 and the second lens 2201 together can improve the relative positional accuracy between these lenses, and facilitate manufacturing.

Similarly to Example 1, this example assumes a maximum half angle of 50° as the design viewing angle in the design appellation. More specifically, the maximum angle of the principal ray of the display light passing through the pupil plane SP is set to 50°, and the display optical system 2000 with a wide viewing angle can be achieved.

FIG. 8 illustrates the exit angle β of the principal ray from the display element relative to the angle of view α of the display optical system 2000. It may be understood from FIG. 8 that the exit angle β at the maximum half angle of view is −15.0°, and the maximum absolute value of the exit angle β is smaller than 30°. Thereby, light amount unevenness can be reduced. Since the exit angle β at the maximum half angle of view is negative, the size of the display element can be reduced.

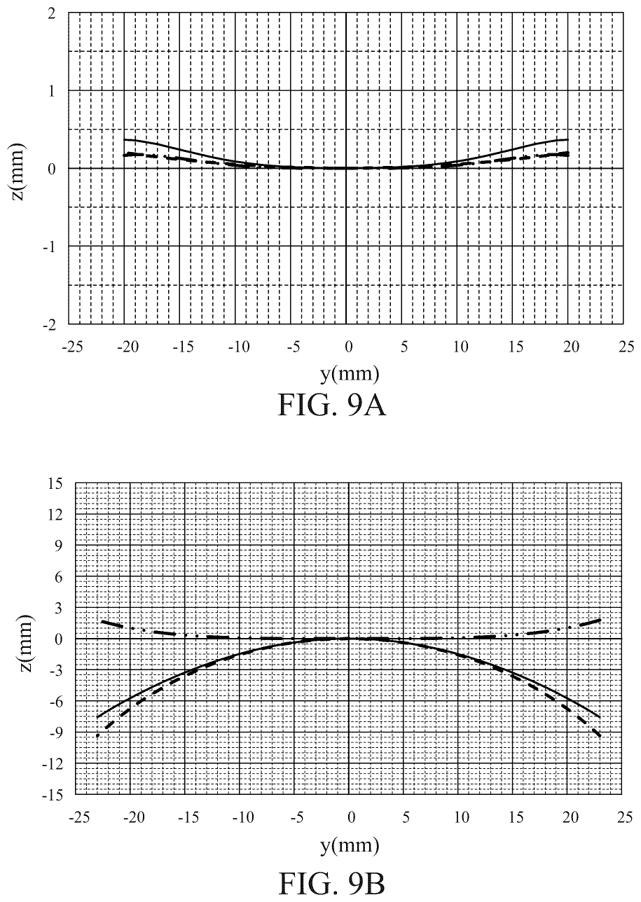

FIGS. 9A and 9B illustrate, with solid lines, the sectional shape including the optical axis of the R1 surface of the first lens 2101 and the sectional shape including the optical axis of the R2 surface of the fourth lens 2301, respectively. The R1 surface of the first lens 2101 and the R2 surface of the fourth lens 2301 have sectional shapes that cannot be expressed by conic sections.

FIG. 9A further illustrates the paraxial curvature surface shape of a section including the optical axis of the R1 surface of the first lens 2101 by a broken line, and a difference from the sectional shape illustrated by the solid line by an alternate long and two short dashes line. FIG. 9B further illustrates the paraxial curvature surface shape of a section including the optical axis of the R2 surface of the fourth lens 2301 by a broken line, and a difference from the sectional shape illustrated by the solid line by an alternate long and two short dashes line.

In this example, the sag amount SagA of the sectional shape including the optical axis at the end of the effective ray area of the R1 surface of the first lens 2101 (maximum effective diameter Φ40 mm) is 0.37 mm, and the sag amount SagR of the paraxial curvature surface shape is 0.20 mm. The asphericity at the end of the effective ray area is |(SagA−SagR)/SagR|=85%.

The sag amount SagA of the sectional shape including the optical axis at the end of the effective ray area of the R2 surface of the fourth lens 2301 (maximum effective diameter Φ46 mm) is −7.56 mm, and the sag amount SagR of the paraxial curvature surface shape is −9.34 mm. The asphericity at the end of the effective ray area is |(SagA−SagR)/SagR|=19.0%.

Thus, setting the asphericity at the end of the effective ray area to 50% or more, particularly on the R1 surface of the first lens 2101 can provide sufficient effects such as reducing the exit angle β and reducing the field curvature and astigmatic difference with high accuracy for each angle of view. However, even if the asphericity at the end of the effective ray area is less than 30%, the above effects can be obtained to a certain extent.

This example can secure high optical performance and reduce chromatic aberration and weight for the display optical system 2000.

A description will now be given of numerical values corresponding to Examples 1 and 2, respectively. In the surface data, a surface number i indicates an i-th surface when counted from the pupil plane side. r represents a radius of curvature (mm) of an i-th surface, and d represents a lens thickness or air gap (mm) between i-th and (i+1)-th surfaces. d represents a value in a case where no adjustment is made. nd is a refractive index for the d-line of a material of an i-th optical element. vd is an Abbe number of the material of the i-th optical element based on the d-line as the reference. The Abbe number vd based on the d-line as the reference is expressed as vd=(Nd−1)/(NF−NC) where Nd, NF and NC are refractive indices for the d-line, F-line (with a wavelength of 486.1 nm) and C-line in the Fraunhofer line.

An asterisk “*” next to the surface number means that the surface has an aspheric shape. The aspheric shape is expressed by the following equation:

$$x ( h ) = \frac{{h}^{2} / r}{1 + \sqrt{1 - ( 1 + k ) {( h / r )}^{2}}} + A 4 \cdot {h}^{4} + A 6 \cdot {h}^{6} + A 8 \cdot {h}^{8} + A 10 \cdot {h}^{10} + ⋯$$

where x is a displacement amount in the optical axis direction at a position of height h from the optical axis relative to a surface vertex, R is a paraxial radius of curvature, k is a conic constant, and Ai (i=4, 6, 8, 10 . . . ) are the aspheric coefficients of each order. “e±XX” in the conic constant and aspheric coefficient means “×10^{±XX}.”

### Numerical Example 1

UNIT: mm
SURFACE DATA

| Surface No. | r | d | nd | vd |
|---|---|---|---|---|
| 1 (SP) | ∞ | (Variable) | | |
| 2* | 1000.000 | 5.40 | 1.54390 | 56.0 |
| 3* | −106.000 | 0.30 | 1.52000 | 50.0 |
| 4* | −106.000 | (Variable) | | |
| 5* | −110.000 | 5.80 | 1.54390 | 56.0 |
| 6 | −37.300 | 0.30 | 1.52000 | 50.0 |
| 7 | −37.300 | 1.50 | 1.64220 | 22.4 |
| 8* | −51.900 | −1.50 | | |
| 9 | −37.300 | −0.30 | 1.52000 | 50.0 |
| 10 | −37.300 | −5.80 | 1.54390 | 56.0 |
| 11* | −110.000 | (Variable) | | |
| 12* | −106.000 | (Variable) | | |
| 13* | −110.000 | 5.80 | 1.54390 | 56.0 |
| 14 | −37.300 | 0.30 | 1.52000 | 50.0 |
| 15 | −37.300 | 1.50 | 1.64220 | 22.4 |
| 16* | −51.900 | 6.70 | 1.49171 | 57.4 |
| 17* | −27.600 | 2.61 | | |
| 18 | ∞ | 0.30 | 1.52000 | 50.0 |
| 19 | ∞ | 0.10 | 1.52000 | 50.0 |
| 20 | ∞ | 0.40 | 1.51633 | 64.1 |
| Image Plane | ∞ | | | |

| ASPHERIC DATA | | |
|---|---|---|
| 2nd Surface | | |
| K = 0.00000e+00 A 4 = 8.07611e−06 A 6 = −1.15573e−08 A 8 = 8.41102e−12 | | |
| 3rd Surface | | |
| K = 2.90000e+00 | | |
| 4th Surface | | |
| K = 2.90000e+00 | | |
| 5th Surface | | |
| K = 1.88000e+01 | | |
| 8th Surface | | |
| K = −7.00000e−01 | | |
| 11th Surface | | |
| K = 1.88000e+01 | | |
| 12th Surface | | |
| K = 2.90000e+00 | | |
| 13th Surface | | |
| K = 1.88000e+01 | | |
| 16th Surface | | |
| K = −7.00000e−01 | | |
| 17th Surface | | |
| K = 0.00000e+00 A 4 = 2.44265e−06 A 6 = 1.09841e−08 A 8 = −8.88768e−12 | | |
| | No Diopter Adjustment | −4D Adjustment |
| Focal Length | 23.09 | 22.83 |
| d 1 | 12.00 | 12.63 |
| d 4 | 1.75 | 1.12 |
| d11 | −1.75 | −1.12 |
| d12 | 1.75 | 1.12 |

### Numerical Example 2

UNIT: mm
SURFACE DATA

| Surface No. | r | d | nd | vd |
|---|---|---|---|---|
| 1 (SP) | ∞ | 12.00 | | |
| 2* | 1000.000 | 5.00 | 1.49171 | 57.4 |
| 3* | −120.000 | 0.30 | 1.52000 | 50.0 |
| 4* | −120.000 | 1.90 | 1.64220 | 22.4 |
| 5 | ∞ | 0.30 | 1.52000 | 50.0 |
| 6 | ∞ | 7.20 | 1.54390 | 56.0 |
| 7 | −49.000 | 2.09 | | |
| 8* | −53.000 | −2.09 | | |
| 9 | −49.000 | −7.20 | 1.54390 | 56.0 |
| 10 | ∞ | −0.30 | −1.52000 | 50.0 |
| 11 | ∞ | −1.90 | 1.64220 | 22.4 |
| 12* | −120.000 | 1.90 | | |
| 13 | ∞ | 0.30 | 1.52000 | 50.0 |
| 14 | ∞ | 7.20 | 1.54390 | 56.0 |
| 15 | −49.000 | 2.09 | | |
| 16* | −53.000 | 0.00 | | |
| 17* | −53.000 | 4.00 | 1.54390 | 56.0 |
| 18* | −33.000 | 0.82 | | |
| 19 | ∞ | 0.30 | 1.52000 | 50.0 |
| 20 | ∞ | 0.10 | 1.52000 | 50.0 |
| 21 | ∞ | 0.40 | 1.51633 | 64.1 |
| Image Plane | ∞ | | | |

ASPHERIC DATA
2nd Surface
K = 0.00000e+00 A 4 = 4.69747e−06 A 6 = −1.04348e−08 A 8 = 3.20166e−12
3rd Surface
K = 0.00000e+00 A 4 = 6.53685e−07 A 6 = −1.98380e−09 A 8 = 1.52535e−12
4th Surface
K = 0.00000e+00 A 4 = 6.53685e−07 A 6 = −1.98380e−09 A 8 = 1.52535e−12
8th Surface
K = −1.20000e+00
12th Surface
K = 0.00000e+00 A 4 = 6.53685e−07 A 6 = −1.98380e−09 A 8 = 1.52535e−12
16th Surface
K = −1.20000e+00
17th Surface
K = −1.20000e+00
18th Surface
K = 0.00000e+00 A 4 = 7.23521e−06 A 6 = −3.73503e−09 A 8 = 3.90389e−12

| | |
|---|---|
| Focal Length | 22.27 |

### Display Apparatus

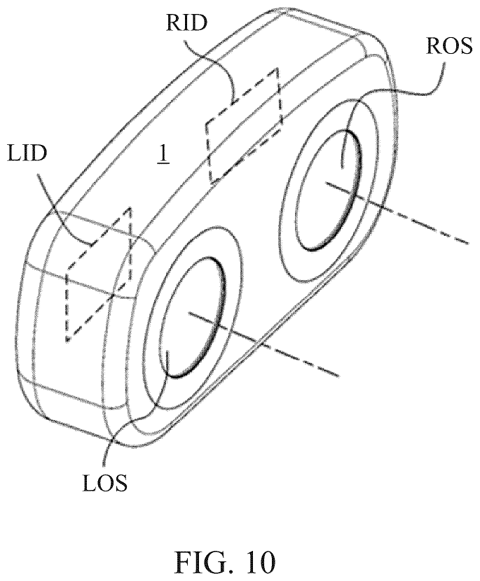

FIG. 10 illustrates a head mounted display (HMD) 1 as a display apparatus using any one of the display optical systems according to Examples 1 and 2. The HMD 1 is mounted on the head (in front of the eyes) of the observer by means of an unillustrated attachment gear.

The HMD 1 includes a right-eye display element RID, a left-eye display element LID, a right-eye display optical system ROS configured to guide the display light from the right-eye display element RID to the observer's right eye, and a left-eye display optical system LOS configured to guide the display light from the left-eye display element LID to the observer's left eye.

Using the display optical systems illustrated in Examples 1 and 2 as the right-eye and left-eye display optical systems ROS and LOS can achieve an HMD that allows the observer to observe good images.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a lightweight display optical system.

This application claims priority to Japanese Patent Application No. 2024-084473, which was filed on May 24, 2024, and which is hereby incorporated by reference herein in its entirety.

What is claimed is:

1. A display optical system configured to guide light from a display surface of a display element to a pupil plane, the display optical system comprising, in order from a pupil plane side to a display surface side:
a first lens unit;
a first transmissive reflective surface;
a second lens unit;
a second transmissive reflective surface; and
a third lens unit,
wherein the second lens unit includes a lens having positive on-axis refractive power and a lens having negative on-axis refractive power and an Abbe number based on d-line different from that of the lens having the positive on-axis refractive power,
wherein at least one of the first lens unit and the third lens unit has a curved surface that serves as an interface with air in a range in which the light from the display surface passes, and
wherein the Abbe number based on the d-line of the lens having the positive on-axis refractive power is larger than the Abbe number based on the d-line of the lens having the negative on-axis refractive power.

2. The display optical system according to claim 1, wherein the following inequality is satisfied:
$$20 \leq v 1 - v 2$$
where v1 is the Abbe number based on the d-line of the lens having positive on-axis refractive power, and v2 is the Abbe number based on the d-line of the lens having negative on-axis refractive power.

3. The display optical system according to claim 1, wherein the curved surface is aspheric.

4. The display optical system according to claim 3, wherein each of the first lens unit and the third lens unit has an aspheric surface.

5. The display optical system according to claim 1, wherein the lens having positive on-axis refractive power and the lens having negative on-axis refractive power are cemented to each other.

6. The display optical system according to claim 5, wherein the lens having positive on-axis refractive power and the lens having negative on-axis refractive power are cemented to each other via a waveplate.

7. The display optical system according to claim 5, wherein a cemented surface between the lens having positive on-axis refractive power and the lens having negative on-axis refractive power is flat or spherical.

8. The display optical system according to claim 1, wherein the following inequality is satisfied:
$$0.25 \leq \vert f 2 / f 1 \vert \leq 4.$$
where f1 is a focal length of the lens having positive on-axis refractive power, and f2 is a focal length of the lens having negative on-axis refractive power.

9. The display optical system according to claim 1, wherein the second lens unit has an air gap with the first transmissive reflective surface or the second transmissive reflective surface.

10. The display optical system according to claim 9, wherein the air gap is changed during focusing.

11. The display optical system according to claim 1, wherein a sum of thicknesses on an optical axis of all lenses included in the display optical system is 20 mm or less.

12. The display optical system according to claim 1, wherein at least one of the lens having positive on-axis refractive power and the lens having negative on-axis refractive power is a resin lens.

13. The display optical system according to claim 1, wherein both the on-axis refractive power of the first lens unit and the on-axis refractive power of the third lens unit are positive.

14. The display optical system according to claim 1, wherein an optical surface opposite to the pupil plane in the first lens unit is a flat surface or a surface having a convex shape toward the pupil plane side.

15. The display optical system according to claim 4, wherein a sectional shape of the aspheric surface of at least one of the first lens unit and the third lens unit is a shape that is not a conic section.

16. The display optical system according to claim 15, wherein the following inequality is satisfied:
$$0.3 \leq \vert ( SagA - SagR ) / SagR \vert$$
where SagR is a sag amount of a paraxial curvature surface shape at an end of an effective ray area of the aspheric surface, and SagA is a sag amount of a sectional shape of the aspheric surface.

17. The display optical system according to claim 1, wherein the first lens unit includes a first lens,
wherein the second lens unit includes a second lens and a third lens,
wherein the third lens unit includes a fourth lens, and
wherein one of the second lens and the third lens is the lens having the positive on-axis refractive power, and the other of the second lens and the third lens is the lens having the negative on-axis refractive power.

18. The display optical system according to claim 1, wherein both the first transmissive reflective surface and the second transmissive reflective surface have a concave shape toward the pupil plane side.

19. The display optical system according to claim 1, wherein a lens closest to the display surface of the second lens unit and a lens closest to the pupil plane of the third lens unit are cemented to each other via the second transmissive reflective surface.

20. The display optical system according to claim 1, wherein a lens closest to the display surface of the first lens unit and a lens closest to the pupil plane of the second lens unit are cemented to each other via the first transmissive reflective surface.

21. The display optical system according to claim 1, wherein a maximum half angle of view made by a principal ray of the light passing through the pupil plane is 30° or more, and
wherein an exit angle of the principal ray from the display element is 35° or less.

22. The display optical system according to claim 1, wherein the exit angle of the principal ray is an angle directed away from an optical axis of the display optical system.

23. The display optical system according to claim 1, wherein the light is guided to the pupil plane via transmission through the second transmissive reflective surface, reflection on the first transmissive reflective surface, reflection on the second transmissive reflective surface, and transmission through the first transmissive reflective surface.

24. A display apparatus comprising:
a display optical system configured to guide light from a display surface of a display element to a pupil plane,
wherein the display optical system includes, in order from a pupil plane side to a display surface side, a first lens unit, a first transmissive reflective surface, a second lens unit, a second transmissive reflective surface, and a third lens unit,
wherein the second lens unit includes a lens having positive on-axis refractive power and a lens having negative on-axis refractive power and an Abbe number based on d-line different from that of the lens having the positive on-axis refractive power,
wherein at least one of the first lens unit and the third lens unit has a curved surface that serves as an interface with air, and
wherein the Abbe number based on the d-line of the lens having the positive on-axis refractive power is larger than the Abbe number based on the d-line of the lens having the negative on-axis refractive power.
